(19) United States
(12) Patent Application Publication
(10) Pub. No.: US 2005/0030665 A1
(43) Pub. Date: Feb. 10, 2005

(54) Tray braking apparatus

(76) Inventor: Shan-Yen Yang, Taoyuan City (TW)

Correspondence Address: SNELL & WILMER;ONE ARIZONA CENTER, 400 EAST VAN BUREN, PHOENIX, AZ, 850040001, US

(21) Appl. No.: 10/889,338

(22) Filed: Jul. 12, 2004

(30) Foreign Application Priority Data
Jul. 30, 2003 (TW) 92120783

(51) Int. Cl. G11B 17/04

(52) U.S. Cl. 360/99.06

(57) ABSTRACT

A tray braking apparatus for disk drives is provided. The braking apparatus includes a chassis, a tray movably connected to the tray, a friction device disposed on the bottom side of the tray, and a stopper pivotally connected to the chassis. The stopper is selectively located in an initial position or a brake position. When the tray moves relative to the chassis, the friction device drives the stopper from the initial position to the brake position to generate frictional force to slow down the relative movement of the chassis and the tray.

### CROSS-REFERENCE TO RELATED APPLICATION

This Application claims priority to Taiwan Patent Application No. 092120783 entitled “Tray Braking Apparatus,” filed on Jul. 30, 2003.

### FIELD OF INVENTION

The present invention relates to a braking apparatus, and more particularly, to a braking apparatus for disk tray of a disk storage apparatus.

### BACKGROUND OF THE INVENTION

The methods of entering and ejecting disks are different based on designs of the disk storage apparatus. In conventional drives, there are designs of inputting disks by directly lifting the cover or putting disks on the tray that moves in and out. Generally speaking, the disk storage apparatus applied in computer peripheral industry often chooses the tray to input and output disks.

When moving the tray with a disk thereon in and out of the disk storage apparatus, the speed of the tray should be carefully controlled to avoid unnecessary vibration and damage to the disk storage apparatus. To solve this problem, a proper design of the braking apparatus of the disk tray is desired. In prior art systems, reversing the motor to slow down the speed of the tray is a popular method, but this method will not only do damage to the motor but also cause unnecessary collision and the tray still can't stop in the proper position. Therefore, there is much to be improved of the braking apparatus.

### SUMMARY OF THE INVENTION

One aspect of the present invention is to provide a braking apparatus for a tray, especially a disk tray of a disk storage apparatus. The braking apparatus of the present invention can control the tray to stop at the proper location and also can reduce unnecessary collision, so as to improve durability of related products.

The braking apparatus of the present invention includes a chassis, a tray movably connected to the chassis, a friction device disposed on the bottom side of the tray and a stopper pivotally connected to the chassis. The stopper is selectively in an initial position or a brake position. When the tray moves relative to the chassis, the friction device drives the stopper from the initial position to the brake position and generates a frictional force to slow down the relative movement of the chassis and the tray. The braking apparatus of the present invention can slow down the speed of the tray and ensure that the tray stops at the proper location at the same time.

The braking apparatus of the present invention also reduces unnecessary contact and collision between elements by controlling the proper stopping location of the tray to increase the durability of the related products.

### BRIEF DESCRIPTION OF THE DRAWINGS

FIG. 1a shows a profile of an embodiment of the present invention.

FIG. 1b shows another profile of the embodiment of the present invention.

FIG. 1c shows another profile of the embodiment of the present invention.

FIG. 1d shows another profile of the embodiment of the present invention.

FIG. 2a shows a profile of the detail component of the braking apparatus of the present invention.

FIG. 2b shows another profile of the detail component of the braking apparatus of the present invention.

### DETAILED DESCRIPTION

The present invention provides a braking apparatus for a tray, especially to a disk tray of a disk storage apparatus.

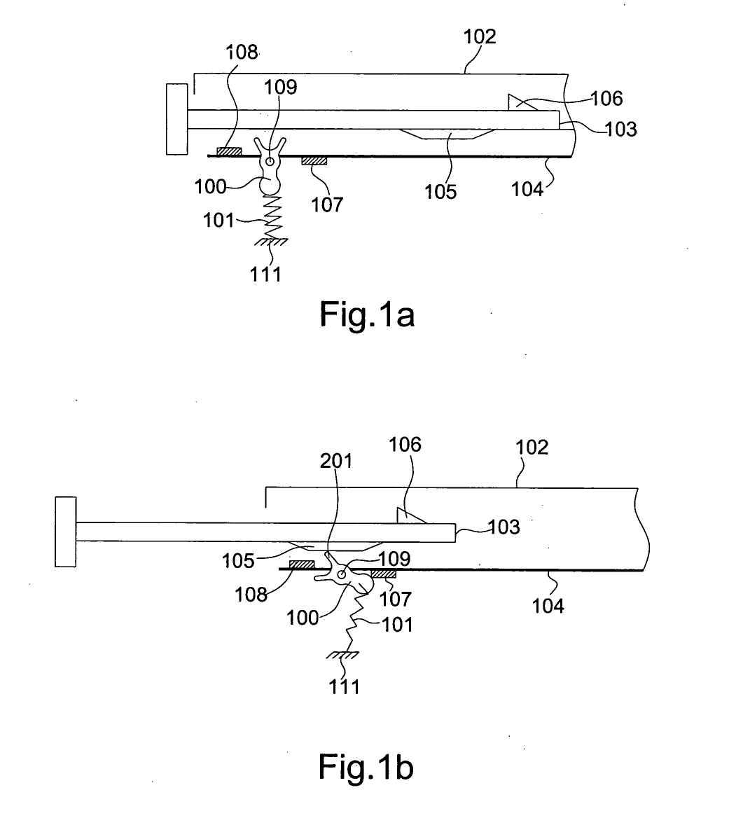

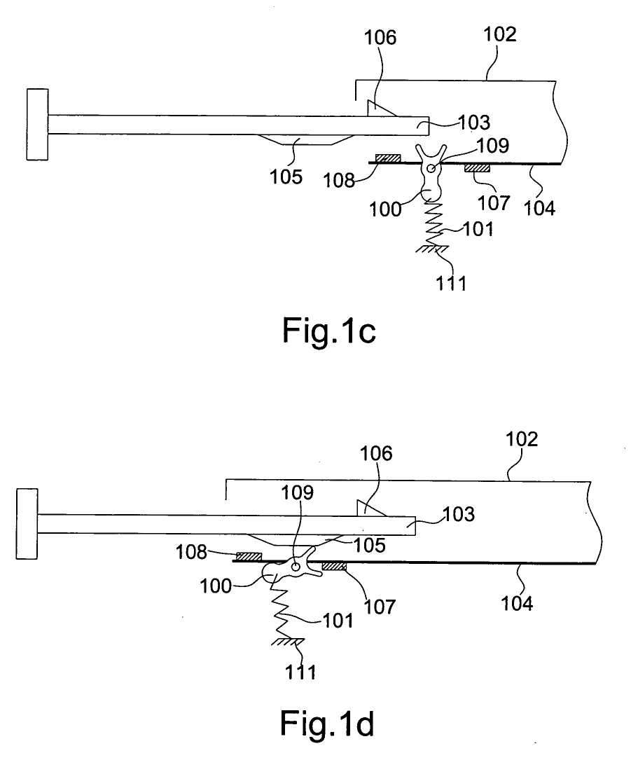

FIGS. 1a-1d show profiles of an exemplary embodiment of the present invention, and are ordered according to the order of operation of the braking apparatus. As shown in FIG. 1a, the tray 103 and the chassis 104 are disposed inside the housing 102, and the chassis 104 is assembled with the housing 102. The tray 103 is in a first position, and includes a convex portion 106 on its topside and a frictional device 105 on its bottom side. The frictional device 105 could be formed as an integrity with the tray 103 and protrude downward or could be other devices with the same function. The chassis 104 includes a first portion 107 and a second portion 108 respectively disposed near the two opposite sides of the stopper 100. The first portion 107 provides a support force to increase the frictional force between the stopper 100 and the frictional device 105. The second portion 108 provides a limitation to avoid the stopper 100 from running too far. In a normal operation state, the second portion 108 doesn't contact with the stopper 100. The stopper 100 is pivotally connected to the chassis 104 via the axis 109 and includes an elastic element 111 connecting to the pedestal 111. The elastic element could be a spring or other devices with the same function. The stopper in FIG. 1a is in an initial position.

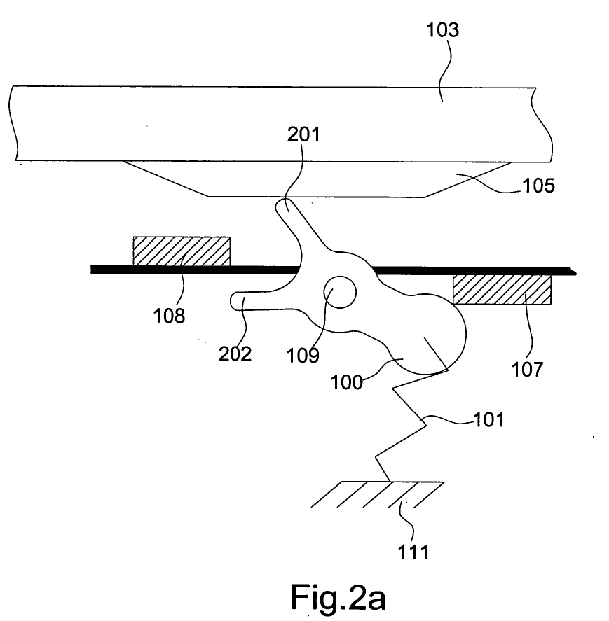

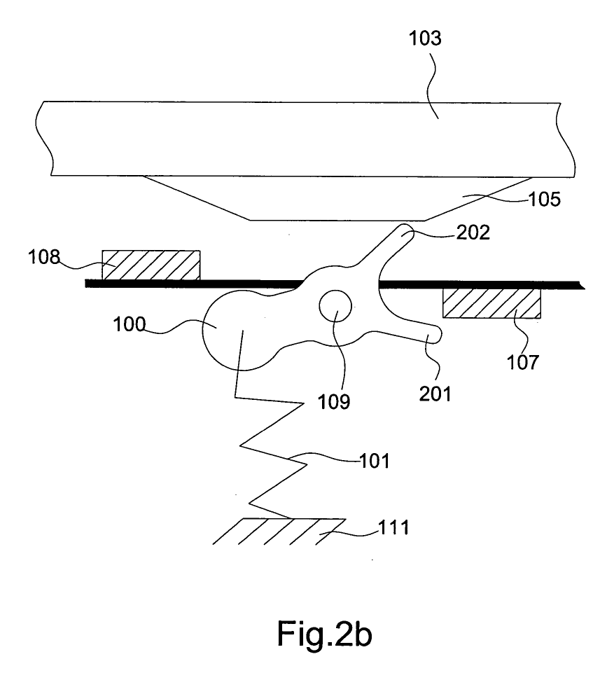

As shown in FIG. 1b and FIG. 2a, the tray 103 moves from the first portion illustrated in FIG. 1b to the second position illustrated in FIG. 1c. When the tray 103 moves out of the housing 102 relatively to the chassis 104, the frictional device 105 under the tray 103 drives the stopper 100 from the initial position to the brake position illustrated in FIG. 1b. The stopper 100 increases the frictional force between the first convex portion 201 and the frictional device 105 by the support force provided by the first portion 107 to slow down the relative movement between the chassis 104 and the tray 103 (as illustrated in FIG. 2a). To further increase the frictional force, materials, for example, rubber and the like, with larger frictional coefficient could be applied to the first convex portion 201. The frictional force can slow down the speed of the tray 103 effectively. The elastic element 101 provides the stopper 100 with an elastic recovery force to make the stopper 100 return to the initial position after the frictional device 105 totally passes (as illustrated in FIG. 1c).

As shown in FIG. 1c, the tray 103 is in the second position. Then the superfluous kinetic energy could be consumed by contact between the convex 106 of the tray 103 and the cover 102. The stopper 100 is forced back to the initial position by the elastic recovery force provided by the elastic element 101.

The process of the tray 103 returning from the second position to the first position is described hereafter. As shown in FIG. 1d and FIG. 2b, the second convex portion 202 of the stopper 100 is driven to rotate by the frictional device 105. It's different from what is shown in FIG. 1b that the second portion 108 of the chassis 104 doesn't contact with the stopper 100. That means the second portion 108 doesn't provide a support force to the stopper 100 and only provides a limitation to avoid the stopper from rotating too much (as illustrated in FIG. 2b). As shown in FIG. 2b, the elastic element 101 provides an elastic recovery force to make the stopper 100 return to the initial position after the frictional device 105 totally passes. As shown in FIG. 1a, as the tray 103 returns to the first position, the stopper 100 returns to the initial position.

In other embodiments, the locations of the first portion 107 and the second portion 108 could be adjustable according to practical requirement. Besides, the frictional force between the frictional device 105 and the first convex portion 201 or the second convex portion 202 is also adjustable to one-way brake or two-way brake. Details are not described here.

While the invention has been described in connection with what is presently considered to be the most practical and preferred embodiments, it is to be understood that the invention is not to be limited to the discovered embodiments. The invention is intended to cover various modifications and equivalent arrangement included within the spirit and scope of the appended claims.

1. A braking apparatus comprising:
a chassis;
a tray slidably connecting to the chassis, the tray selectively being at a first position and a second position;
a frictional device disposed under the tray; and
a stopper pivotally connecting to the chassis, the stopper selectively being at an initial position and a brake position;
wherein as the tray moves from the first position to the second position, the frictional device drives the stopper from the initial position to the brake position for generating a frictional force between the frictional device and the stopper to slow down a relative speed between the chassis and the tray.

2. The braking apparatus of claim 1, wherein the chassis further comprises a first portion, and as the stopper is at the brake position, the first portion provides a support force to increase the frictional force between the frictional device and the stopper.

3. The braking apparatus of claim 1, wherein the chassis further comprises a second portion, and as the tray moves from the second position to the first position, the second portion prevents the stopper driven by the frictional device from moving beyond a predetermined limitation.

4. The braking apparatus of claim 1, wherein the stopper further comprises an elastic element.

5. The braking apparatus of claim 4, wherein the elastic element provides an elastic force to the stopper to return to the initial position.

6. The braking apparatus of claim 5, wherein the elastic element includes a spring.

7. The braking apparatus of claim 1, wherein the tray includes a disk tray.

8. The braking apparatus of claim 1, wherein a direction of the frictional force is opposite to movement direction of the tray.

9. The braking apparatus of claim 1, wherein the frictional device and the tray are formed integrally.

10. The braking apparatus of claim 1, wherein the stopper includes two convex portions with respective different frictional coefficients.

11. A braking apparatus comprising:
a chassis including a first portion;
a tray slidably connecting to the chassis, the tray selectively being at a first position and a second position;
a frictional device disposed under the tray; and
a stopper pivotally connecting to the chassis, the stopper selectively being at an initial position and a brake position, the first position providing the stopper a support force to slow down the speed between the stopper and the frictional device as the stopper is at the brake position;
wherein as the tray moves from the first position to the second position, the frictional device drives the stopper from the initial position to the brake position for generating a frictional force between the frictional device and the stopper to slow down a relative speed between the chassis and the tray.

12. The braking apparatus of claim 11, wherein the chassis further comprises a second portion, and as the tray moves from the second position to the first position, the second portion prevents the stopper driven by the frictional device from moving beyond a predetermined limitation.

13. The braking apparatus of claim 11, wherein the stopper further comprises an elastic element.

14. The braking apparatus of claim 13, wherein the elastic element provides an elastic force to the stopper to return to the initial position.

15. The braking apparatus of claim 14, wherein the elastic element includes a spring.

16. The braking apparatus of claim 11, wherein the tray includes a disk tray.

17. The braking apparatus of claim 11, wherein a direction of the frictional force is opposite to movement direction of the tray.

18. The braking apparatus of claim 11, wherein the frictional device and the tray are formed integrally.

19. The braking apparatus of claim 11, wherein the stopper includes two convex portions with respective different frictional coefficients.
